(19) United States
(12) Patent Application Publication
(10) Pub. No.: US 2024/0397059 A1
(43) Pub. Date: Nov. 28, 2024

(54) PANOPTIC MASK PROPAGATION WITH ACTIVE REGIONS

(71) Applicant: Adobe Inc., San Jose, CA (US)

(72) Inventors: Joon-Young LEE, San Jose, CA (US); Seoung Wug OH, San Jose, CA (US); Ho Kei CHENG, Champaign, IL (US); Brian PRICE, Pleasant Grove, UT (US)

(21) Appl. No.: 18/322,310

(22) Filed: May 23, 2023

(51) Int. Cl. H04N 19/172; G06V 10/25; H04L 9/32

(52) U.S. Cl. CPC H04N 19/172; G06V 10/25; H04L 9/3213; G06V 2201/07

(57) ABSTRACT

A method includes receiving a frame depicting an object. The frame is one frame of a plurality of frames of a video sequence. The method further includes encoding a plurality of tokens of the frame. Each token is a representation of a grid of pixels of the frame. The method further includes selecting a subset of tokens for decoding based on a likelihood of a token satisfying a confidence threshold. The token satisfies the confidence threshold based on a confidence score of the token including a past object in a past frame. The method further includes decoding the subset of tokens using a decoder.

### BACKGROUND

Panoptic segmentation is a technique of classifying each pixel in an image as belonging to a particular object. In this manner, particular objects of an image are segmented, or otherwise delineated from other objects of the image. For example, panoptic segmentation can segment individual people in an image as person 1, person 2, etc. Video panoptic segmentation segments objects throughout the video. That is, the segmented objects are propagated through each frame of multiple frames included in a video.

### SUMMARY

Introduced here are techniques/technologies that perform video panoptic segmentation of multiple objects in a temporally coherent manner. The segmentation system described herein leverages spatial redundancy in each frame of a video sequence to segment multiple objects simultaneously. The segmentation system identifies objects to segment using a memory representation of objects segmented in previous frames.

More specifically, in one or more embodiments, the segmentation system segments multiple objects in a single pass by selectively decoding only regions of the frame including objects. The regions of the frame including objects are identified using memory representations of objects in previous frames. Specifically, a memory key encodes a robust representation of visual information on its underlying region in previous frames for accurate memory readout, a memory value encodes detailed information like mask probabilities along with corresponding visual information for accurate mask decoding, and an existence metric encodes an existence of a particular masked object for active region selection. The memory representations, capturing object information of previous frames in the video sequence, are applied to portions of an input frame. Subsequently, the segmentation system selects portions of the input frame to decode that have a high likelihood of including a past object identified in a past frame. Other portions of the input frame are not decoded as such portions likely include spatially redundant information. In this manner, the segmentation system can segment multiple objects of a frame in a single pass, and the segmented objects are temporally coherent with respect to objects in previous frames.

Additional features and advantages of exemplary embodiments of the present disclosure will be set forth in the description which follows, and in part will be obvious from the description, or may be learned by the practice of such exemplary embodiments.

### DETAILED DESCRIPTION

One or more embodiments of the present disclosure include a segmentation system that leverages the spatial redundancy in frames of a video to segment objects in the video. Generally, video panoptic segmentation may be performed in two stages. In a first stage, conventional techniques segment a group of pixels corresponding to an object in one frame of a video. In a next stage, conventional techniques propagate the segmented pixels to subsequent frames of the video. Some conventional approaches repeat this two-stage process for each segmented object in the frame such that each object is processed independently. After the objects have been segmented independently, a final image is produced which fuses each independently segmented object. However, these conventional approaches are time consuming and inaccurate. For example, these approaches assume that each frame is independent, resulting in temporal coherence issues. Because of the temporal incoherence of each frame and the objects of each frame, objects may be displayed with artifacts that make the object appear wavy, fuzzy, and/or removed altogether in some frames.

Other conventional approaches utilize a system configured to identify a predetermined number of objects (e.g., N objects) in a video frame. However, these approaches consume the same processing power regardless of the number of objects segmented in a frame (e.g., if there is less than N objects) and the accuracy of the segmented objects are dependent on the order of the processed objects. For example, processing a first object of N objects first produces a different result from processing the first object of N objects second.

To address these and other deficiencies in conventional systems, the segmentation system of the present disclosure leverages spatial redundancy in video frames to process multiple objects in a frame simultaneously. By identifying and decoding only active regions including objects of a frame, the computational cost to decode the objects of the frame is reduced. Specifically, the segmentation system decodes only portions of the frame corresponding to objects of interest, instead of decoding an entire frame multiple times for each object. In this manner, the segmentation system expends fewer resources decoding the entire frame and only dedicates resources to decoding the action regions of the frame. By more efficiently managing decoding resources, the segmentation system can simultaneously decode multiple objects in each frame, improving the decoding speed of video panoptic segmentation. Additionally, computing resources such as power, bandwidth, and memory are conserved by reducing the size of the decoded portion of the frame.

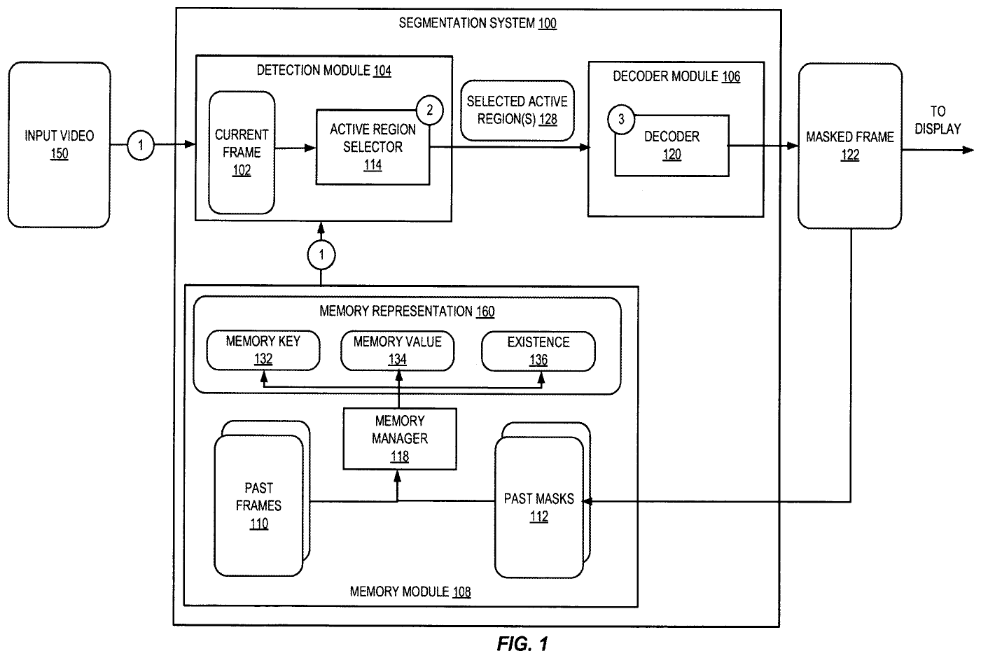

FIG. 1 illustrates a diagram of a process of performing panoptic segmentation using selective regions of a frame, in accordance with one or more embodiments. As shown in FIG. 1, embodiments include a segmentation system 100. The segmentation system 100 includes a detection module 104, a memory module 108, and a decoder module 106. When performing panoptic segmentation of a video, segmented objects are propagated through each frame of the video sequence. Accordingly, the segmentation system 100 is configured to segment objects of each frame using memory of the segmented objects in the previous frames of the video sequence.

At numeral 1, the detection module 104 receives an input video 150. The input video 150 may be a computer-generated video, a video captured by a video recorder (or other sensor), and the like. The detection module 104 may first partition the input video 150 into frames, where each frame of input video 150 is an instantaneous image of the input video 150.

A current frame 102 is the frame at time t processed by the segmentation system 100. The current frame 102 at time t is an image depicting an object. After processing by the segmentation system 100, the current frame 102 at time t results in a corresponding masked frame 122 at time t. The masked frame 122 is a probability distribution of each pixel belonging to a mask of the object. Additionally or alternatively, the masked frame 122 identifies the object using binary pixel values. For example, pixels set to a value of “0” correspond to a low probability of a pixel belonging to an object while pixels set to a value of “1” correspond to a high probability of a pixel belonging to an object. An input frame at a time t+1 (not shown) may result in the current frame 102 at time t becoming a frame of the set of past frames 110, and the masked frame 122 at time t becoming a frame of the set of past masks 112.

Also received by the detection module 104 at numeral 1 is a memory representation 160. The detection module 104 identifies whether the current frame 102 includes one or more objects identified in the set of past frames 110 and the set of past masks 112 using memory representations received from the memory module 108. The memory representation 160 can include memory key 132, memory value 134, and existence 136, that the segmentation system 100 uses to propagate learned information through each frame of the video sequence. As described herein, the memory key 132, memory value 134, and existence 136 of the memory representation 160 are dependent on identified objects in the set of past frames 110 and the set of past masks 112. Specifically, the memory key 132 and the memory value 134 encode structural spatial information of the past frames 110 and past masks 112 such as information about each object in the frame. The existence 136 encodes an existence of a particular masked object of the past mask 112.

Past masks of the set of past masks 112 are past frames that have been segmented, resulting in masked objects in the frame. For example, current frame 102 and corresponding masked frame 122 at time t may become a past frame 110 and corresponding past mask at time t+1.

To determine an initial past mask in the set of past masks 112, (e.g., a masked frame at time 0), a user manually selects objects in a frame of a video. The selected objects in the frame are segmented by the segmentation system 100 or third party system, resulting in a frame with masked objects (e.g., past mask 112) corresponding to the frame (e.g., past frame 110).

In some embodiments, a third-party system selects (or identifies) objects in a frame and subsequently masks the selected objects. In these embodiments, the segmentation system 100 receives the initial past mask and the corresponding initial past frame. The memory module 108 then stores the past frames 110 and corresponding past masks 112 obtained from the third-party system.

In yet other embodiments, one or more modules of the segmentation system 100 are configured to detect objects in a frame of a video using any object detection and/or object recognition algorithm. Specifically, one or more modules of the segmentation system 100 performs image panoptic segmentation to segment objects of a frame. For example, the segmentation system 100 may include a convolutional neural network (CNN) or other type of neural network to segment objects of the frame.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

After receiving an initial past frame 110 and corresponding past mask 112, the memory module 108 can accumulate additional frames of the set of past frames 110 and masks of the set of past masks 112 over time. In a non-limiting example, a first past frame and corresponding past mask is frame 0 and corresponding mask 0 determined at time 0 of a video sequence. Frame 1 (or some other next frame in the sequence of video frames) is current frame 102 at any time after time 0. Frame 1 is input into the segmentation system 100 for processing, as described herein. Subsequently, frame 1 and the corresponding masked frame 122 (determined during the processing of frame 1, as described herein) may become part of the set of past frames 110 and the set of past masks 112.

In some embodiments, the memory manager 118 algorithmically combines (e.g., averages, etc.) one or more past frames to determine the set of past frames 110 and/or masks of the set of past masks 112. In other embodiments, memory manager 118 selects frames and masks to become part of the set of past frames 110 and the set of past masks 112 that satisfy one or more criteria. For example, frames and masks that satisfy a temporal threshold are stored as past frames 110 and the set of past masks 112. Specifically, the memory manager 118 may compare a location of pixels of a past frame to the corresponding location of the pixels in a candidate frame (a frame being evaluated by the memory manager 118 as potentially being added to the set of pasts frames 110). If the location of one or more pixels between the past frame and candidate frame are within a threshold distance, then the memory manager 118 determines that the candidate frame and past frame are temporally related. In some embodiments, the memory manager 118 performs the above evaluation on a candidate mask (e.g., a mask being evaluated by the memory manager 118 as potentially be added to the collection of past masks 112). In some embodiments, responsive to determining that the candidate frame is temporally related to a past frame 110, the memory manager determines that the corresponding candidate mask is temporally related to a past mask of the past masks 112.

In some embodiments, the memory module 108 maintains a number of past frames 110 and past masks 112. For example, the memory module 108 stores N most recent past frames 110 and past masks 112. In other embodiments, the memory module 108 accumulates and stores every past frame and past mask in the set of past frames 110 and past masks 112. The set of past frames 110 and past masks 112 are used by the memory module 108 to determine the memory representation of the video, as described herein.

At numeral 2, using the memory representations received from the memory module 108, the detection module 104 selects grids of the current frame 102 for decoding by the decoder module 106. Specifically, the active region selector 114 selects active regions 128 to pass to the decoder module 106. The active region 128 is an encoded representation of an initial estimation of an object location in the current frame 102, based on objects identified from past frames 110 and past masks 112. By selectively passing active regions 128 to the decoder module 106, the decoder 120 decodes regions of the current frame 102 that are likely to include a past object of a past frame.

At numeral 3, the decoder 120 receives one or more active regions 128 and decodes the region of the current frame 102 identified in the active region 128. The decoder 120 does not decode regions of the current frame 102 outside of the active region 128. By excluding the spatially redundant regions of the current frame 102 from the decoder 120, the decoder 120 has more bandwidth to decode regions of the current frame 102 including objects. Decoding multiple objects of the current frame 102 simultaneously means that the decoder 120 does not have to decode each object of the current frame 102 sequentially. Specifically, the decoder 120 decodes the active regions 128 to identify objects in the current frame 102, and overlays one or more visual indicators over the objects of the current frame 102 to mask them. Such overlayed visual indicators may be colors, patterns, and the like, displayed to the user. The masked frame 122 masks objects of the current frame 102. In some embodiments, the masked frame 122 is displayed for a user as an output of the segmentation system 100. In other embodiments, the masked frame 122 is communicated to one or more devices for subsequent processing.

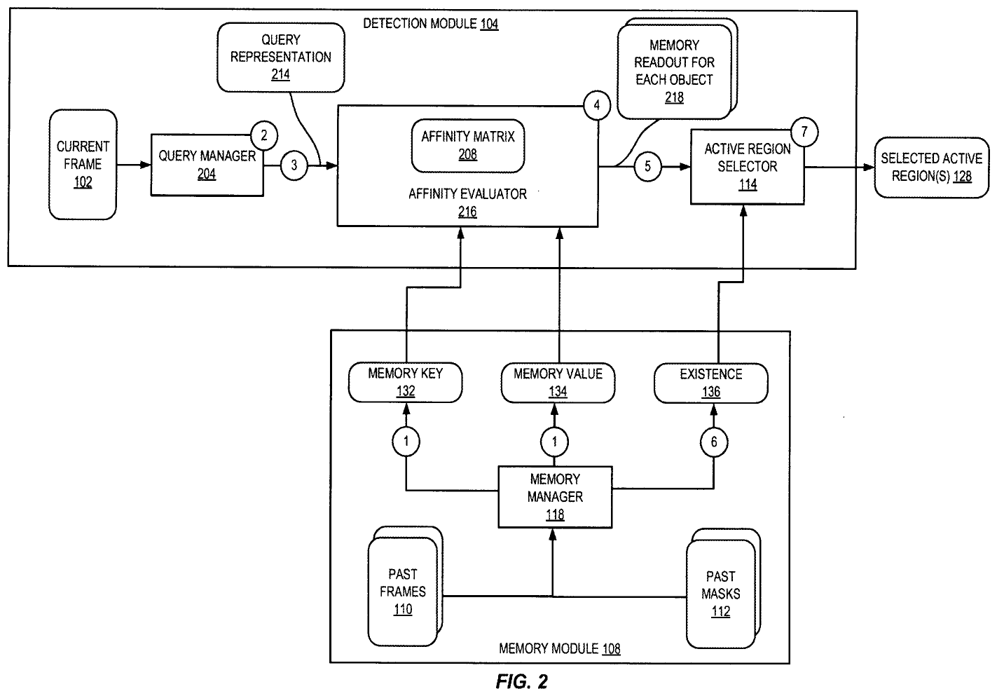

FIG. 2 illustrates a diagram of a process of selecting regions of a frame for decoding, in accordance with one or more embodiments. At numeral 1, the memory manager 118 determines a memory key 132 and a memory value 134 using the past frames 110 and past masks 112. The memory key 132 and the memory value 134 encode structural spatial information of the past frames 110 and past masks 112 such as information about each object in the frame. Specifically, the memory key 132 encodes a representation of visual information on its underlying region in past frames 110 and/or past masks 112 for accurate memory readout, and the memory value 134 encodes detailed information like mask probabilities along with corresponding visual information of the past frames 110 and/or past masks 112 for accurate mask decoding. The memory key at a particular local region is the same across different objects in an image, and the memory value is determined for each masked object. To create the memory key 132 and memory value 134, the memory manager 118 tokenizes the past frames 110 and pasts masks 112 by dividing the past frames 110 and past masks 112 into tokens including grids of pixels. Subsequently, feature maps are determined (using a CNN for instance) of each token of the memory key 132 and memory value 134. The memory manager 118 encodes grids that include objects using any suitable mechanism such as one-hot encoding.

At numeral 2, the query manager 204 tokenizes the current frame 102 by dividing the current frame 102 into tokens, each token mapped to a grid of pixels. The tokens, representing a grid of pixels of a predetermined dimension, become a query. The query manager 204 determines a query representation 214 (e.g., a numerical representation of the query) using a feature extractor (such as a CNN) or other encoder. Encoding the current frame 102 into a plurality of feature maps or other numerical representation allows the detection module 104 to identify objects of the current frame 102 using memory representations (e.g., memory key 132, memory value 134, and/or existence 136) as described herein. At numeral 3, the query manager 204 passes the query representation 214 to the affinity evaluator 216.

At numeral 4, the affinity evaluator 216 creates an affinity matrix 208 by comparing every token of the query representation 214 to the memory key 132. The affinity matrix 208 transfers knowledge from the memory (e.g., the masked objects of the past masks 112) to the current frame 102 by identifying whether every pixel in the current frame 102 is similar to any pixel in past frames 110 of masked objects. For example, an element of the affinity matrix 208 may be high if a pixel (or a grid of pixels) represented by the element of the affinity matrix 208 is similar in both the current frame and a past frame.

Also at numeral 4, the affinity evaluator 216 identifies specific objects of the past masks 112. Specifically, the affinity evaluator 216 applies the memory value 134 to the affinity matrix 208. In this manner, memory readouts 218 for each object of the past masks 112 are determined. At numeral 5, the memory readout 218 for each object is passed to the active region selector 114. The memory readout 218 is a representation of each object that is likely present in the current frame.

At numeral 6, the memory manager 118 creates the existence metric 136. The existence metric 136 is a down sampled representation of masked objects of a past mask 112. As described herein, each past mask 112 includes a number of masked objects. The memory manager 118 tokenizes a past mask 112 by dividing the past mask 112 into tokens, each token including a grid of pixels. Each token of the existence metric 136 indicates a likelihood of the grid including a pixel of a particular masked object of the past masks 112. The memory manager 118 determines the existence metric 136 of each masked object in the past mask 112 by evaluating whether each pixel in the grid includes the masked object. In this manner, the existence 136 encodes an existence of a particular masked object of the past mask 112 (e.g., a probability, a confidence score, etc.). As described above, the memory key at a particular local region is the same across different objects in an image, while the memory value and the existence metric are computed for each masked object.

In a non-limiting example, the memory manager 118 tokenizes a past mask into 16 pixel by 16 pixel grids. If a grid of the grid of pixels includes a single pixel corresponding to a particular masked object in the past mask, the memory manager 118 sets the token of existence metric 136 to a high confidence score. If a grid of the grid of pixels likely does not include a single pixel corresponding to the particular masked object in the past mask, then the memory manager 118 sets the token of existence 136 to a low confidence score.

At numeral 7, instead of decoding the entire feature map of each memory readout 218 corresponding to each object, the active region selector 114 selects a subset of tokens of each memory readout for decoding that are most likely to include past objects identified in past frames. The active region selector 114 does not select tokens for decoding that likely do not include a past object. Although not all tokens of the frame are decoded, the frame can still be accurately compiled by the compiler 328 by leveraging the spatial redundancy of the current frame 102 and the past frames 110.

The active region selector 114 selects a subset of tokens of each memory readout 218 for decoding based on a confidence score of the token satisfying a threshold. The active region selector 114 determines the confidence score by applying the existence metric 136 to memory readouts 218 for each object. In effect, the active region selector 114 is identifying tokens of the memory readout 218 of the current frame 102 in which there is a high confidence of the presence of an object, based on previous objects identified in previous frames/masks. For example, the active region selector 114 determines a high confidence score when pixels of a particular masked object in previous mask are similar to pixels of the encoded memory representation. Tokens with confidence scores satisfying a threshold are determined to be active regions in which there is a high confidence of the presence of an object. Such high confidence active regions are selected active regions 128. As described herein, the selected active regions 128 are passed to the decoder module 106 for decoding.

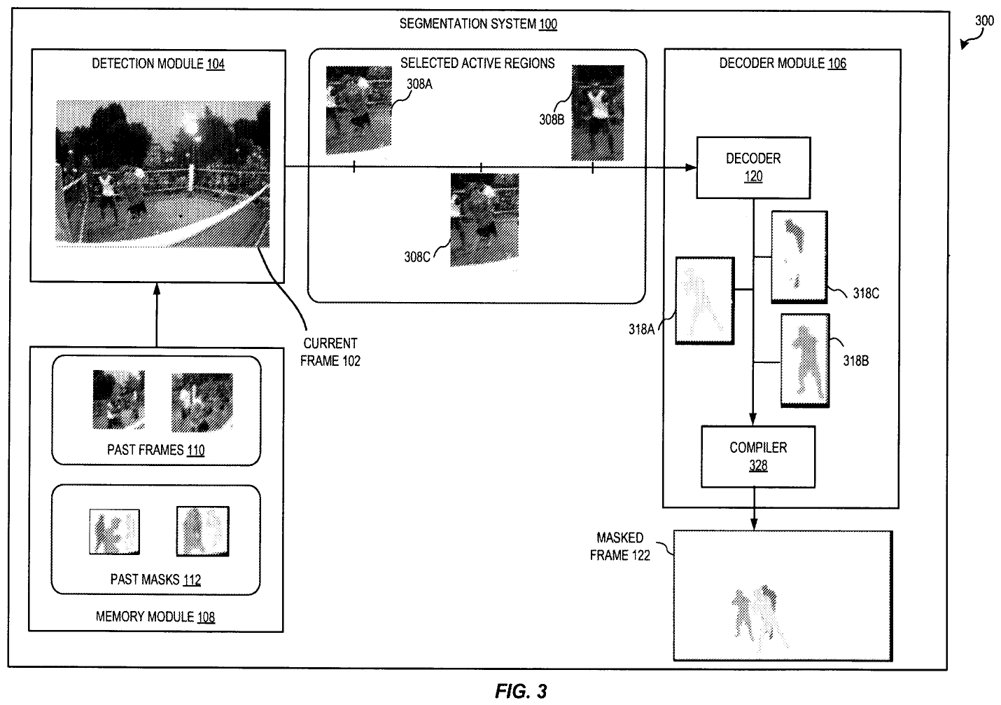

FIG. 3 illustrates another diagram of a process of performing panoptic segmentation using selective regions of a frame, in accordance with one or more embodiments. The current frame 102 of example 300 is an image of a video at a time determined by the detection module 104. For instance, the detection module 104 may partition a video into frames, each frame depicting an image of the video at a particular time. Also shown in example 300, past frames 110 and past masks 112 are stored in the memory module. Such past frames and past masks may be images of the video at previous points in time that have been processed by the segmentation system 100. As described herein, the memory manager 118 of the memory module determines memory representations including representations such as the memory key, the memory value, and the existence metric (not shown). Such memory representations are used to identify active regions of the current frame. Because the current frame 102 includes three objects (e.g., a first boxer, a second boxer, and a referee), there are three active regions corresponding to areas of the current frame that are most likely to include the three objects. As described herein, each active region includes tokens corresponding to a grid of pixels of the current frame. For illustration purposes, the selected active regions include 308A, 308B, and 308C. These active regions are shown as locations of the current frame 102 including an object. However, in practice the active regions passed to the decoder module 106 as feature maps or other encoded representations of the current frame.

In some embodiments, the decoder 120 of the decoder module 106 decodes the received active regions 308A, 308B, and 308C. In addition to decoding the received active regions, the decoder 120 (or some other module) masks the decoded object. As shown, the resulting masked objects 318A, 318B, and 318C correspond to objects of the active region in 308A, 308B, and 308C. The compiler 328 arranges each of the masked objects into the masked frame 122. While the decoder 120 only received tokens of active regions, the masked frame 122 is the same dimension of the current frame 102. This is because the compiler 328 can mask all regions of the frame that do not include action regions by leveraging the spatial redundancy of the current frame 102 to create the masked frame 122. Accordingly, the masked frame 122 may be the same dimension as the current frame, even though only a portion of the masked frame 122 was processed and decoded.

In some embodiments, the compiler 328 arranges the active regions 308A-308C received from the detection module 104 and subsequently the decoder 120 decodes the arrangement of the active regions (e.g., a single feature map). For example, as shown, the active regions 308A-308C are rectangular grids around the objects of interest in the current frame. However, in some embodiments, the active regions may be an irregular shape (e.g., not rectangular). When the active region is an irregular shape, the compiler 328 can merge one or more active regions to convert the active region shape into a regular shape (e.g., a rectangular shape). In some embodiments, the compiler 328 determines to convert the active region shape depending on the type of decoder 120.

For example, if the decoder 120 is a convolutional decoder, then decoder 120 cannot decode irregularly shaped active regions. Convolutional decoders use rectangular windows in the convolution operation. As a result, if the decoder 120 is a convolutional decoder, the compiler 328 must convert the shape of the active region into a rectangular shape such that the decoder 120 can decode the active region. In contrast, if the decoder 120 is a set-based decoder (e.g., multi-layer perceptron, transformer, etc.), then decoder 120 can decode the irregularly shaped active region. In these embodiments, the compiler 328 does not need to convert the shape of the active region into a regular shape. For example, the set-based decoder can index only the active region for decoding and does not decode any region of the current frame outside of the active region.

In a non-limiting example, the compiler 328 converts the shape of the active region by merging active regions together. However, before the compiler 328 merges the active regions together, the compiler 328 must determine that the active regions to be merged are spatially disjoint. For example, the compiler 328 determines whether each active region is at least r pixels apart. If the active regions are spatially disjoint (e.g., the active regions are at least r pixels apart), the compiler 328 masks the spatially disjoint active regions. For example, the feature map outside of the active region is set to zero. Then the compiler 328 can merge the masked active regions without each of the active regions affecting each other (e.g., overlapping). In this manner, the compiler can adjust the shape of the active regions such that the merged active region is a regular shape (e.g., rectangular).

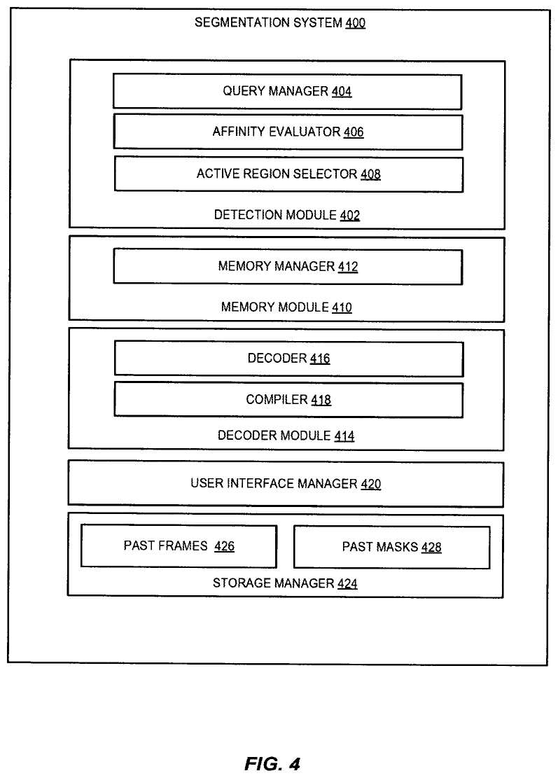

FIG. 4 illustrates a schematic diagram of segmentation system (e.g., “segmentation system” described above) in accordance with one or more embodiments. As shown, the segmentation system 400 may include, but is not limited to, a detection module 402, a memory module 410, a decoder module 414, and a user interface manager 420. The detection module 402 includes the query manager 404, the affinity evaluator 406, and the active region selector 408. The memory module 410 includes the memory manager 412. The decoder module 414 includes the decoder 416 and the compiler 418.

As illustrated in FIG. 4, the segmentation system 400 includes a detection module 402. The detection module 402 includes elements configured to identify objects in frames of a video. For example, the query manager 404 can partition a video input into frames, where each frame is an instantaneous image of the video. Additionally, the query manager 404 tokenizes the current frame by dividing the current frame into tokens, each token mapped to a grid of pixels. The tokens, representing a grid of pixels of a predetermined dimension, become a query. The query manager 404 also determines a query representation (e.g., a numerical representation of the query).

The affinity evaluator 406 of the detection module 402 creates an affinity matrix by comparing every token of the query representation to a memory key. As described herein, the memory key encodes a representation of visual information on its underlying region of the past frames 426 and/or past masks 428. The affinity matrix transfers knowledge from the memory (e.g., the masked objects of the past masks identified using the memory key) to the current frame by identifying whether every pixel in the current frame is similar to any pixel in past frames. The affinity evaluator 406 also identifies specific objects of the past frames 426. Specifically, the affinity evaluator 406 applies a memory value to the affinity matrix. As described herein, the memory value encodes information like mask probabilities along with corresponding visual information associated with past frames. In this manner, the affinity evaluator 406 determines memory readouts for each object of the past masks 428.

The active region selector 408 passes active regions to the decoder module 414 (and specifically, the compiler 418 and/or the decoder 416). As described herein, an active region is an encoded representation of an initial estimation of an object location in a current frame, based on objects identified from past frames 426 and past masks 428. The active region selector 408 selects a subset of tokens for decoding that are most likely to include past objects identified in past frames. Specifically, the active region selector 408 selects a subset of tokens for decoding based on a confidence score satisfying a threshold. The active region selector 408 determines the confidence score by applying an existence metric to memory readouts for each object. As described herein, the existence metric encodes an existence of a particular masked object associated with previous masks. The active region selector 408 determines a high confidence score when pixels of a particular masked object in previous mask are similar to pixels of the encoded memory representation. Active regions with corresponding confidence scores satisfying a threshold are determined to be active regions in which there is a high confidence of the presence of an object.

As illustrated in FIG. 4, the segmentation system 400 includes a memory module 410. The memory module 410 includes a memory manager 412 that determines memory representations (such as memory key, memory value, and existence) as described herein. As described herein, the memory key encodes a representation of visual information on its underlying region of the past frames and/or past masks and the memory value encodes information like mask probabilities along with corresponding visual information of the past frames and/or past masks. The existence is a down sampled representation of masked objects of a past mask. Each token of the existence indicates a likelihood of the grid including a pixel of a particular masked object of the past masks. Such memory representations propagate learned information through each frame of the video sequence. Additionally, the memory manager 412 determines the frames and masks to be stored as past frames 426 and past masks 428 as described herein.

As illustrated in FIG. 4, the segmentation system 400 includes a decoder module 414. The decoder module 414 may host a plurality of neural networks or other machine learning models, such as feature extractors, encoders, or decoders, as described herein. As shown, the decoder module 414 hosts the decoder 416 and the compiler 418, however the decoder module 414 may host other neural networks or other machine learning models. Although the decoder module 414 is shown hosting the decoder 416 and compiler 418, in various embodiments, the neural networks or other encoders, decoders, compilers, etc. may be hosted in different modules. For example, the decoder 416 and compiler 418 may be hosted by their own module and/or in a different host environment. The decoder module 414 may include an execution environment, libraries, and/or any other data needed to execute the machine learning models. In some embodiments, the decoder module 414 may be associated with dedicated software and/or hardware resources to execute the machine learning models.

A decoder 416 of the decoder module 414 decodes the region of the current frame identified in the active regions. By excluding the spatially redundant regions of the current frame from the decoder 416, the decoder 416 has more bandwidth to decode regions of the current frame including objects. Decoding multiple objects of the current frame simultaneously means that the decoder 416 does not have to decode each object of the current frame sequentially. The decoder 416 decodes the active regions to identify objects in the current frame, and overlays one or more visual indicators over the objects of the current frame to mask them.

The compiler 418 arranges each of the masked objects into the masked frame. In some embodiments, the compiler 418 arranges the active regions received from the detection module 402 and subsequently the decoder 416 decodes the arrangement of the active regions (e.g., a single feature map). In some embodiments, the active regions may be an irregular shape (e.g., not rectangular). When the active region is an irregular shape, the compiler 418 may perform additional processing to convert the active region into a regular shape (e.g., rectangular), depending on the decoder 416. As described herein, a convolutional decoder may require the compiler 418 to perform additional processing, while a set-based decoder does not require the compiler 418 to perform additional processing.

As illustrated in FIG. 4, the segmentation system 400 includes a user interface manager 420. For example, the user interface manager 420 allows users to provide video to the segmentation system 400. In some embodiments, the user interface manager 420 provides a user interface through which the user can upload the input video. Alternatively, or additionally, the user interface may enable the user to download video from a local or remote storage location (e.g., by providing an address (e.g., a URL or other endpoint) associated with an image source). In some embodiments, the user interface can enable a user to link an image capture device, such as a camera or other hardware to capture video data and provide it to the segmentation system 400.

Additionally, the user interface manager 420 allows users edit the video as a result of the object segmentation performed on each frame of the video. For example, the user can remove a segmented object, highlight a segmented object, and the like. The user interface manager 420 enables the user to view the resulting output image and/or request further edits to the image.

As illustrated in FIG. 4, the segmentation system 400 also includes the storage manager 424. The storage manager 424 maintains data for the segmentation system 400. The storage manager 424 can maintain data of any type, size, or kind as necessary to perform the functions of the segmentation system 400. The storage manager 424, as shown in FIG. 4, includes the past frames 426 and past masks 428. Past masks 428 are past frames 426 that have been segmented by the segmentation system 400, resulting in masking objects in the past frames 426. Objects of an initial past mask may have been masked according to a user selection, a third a current input frame are known based on the past frames 426 and past masks 428.

Each of the components 402, 410, 414, 420, 422, and 424 of the segmentation system 400 and their corresponding elements (e.g., elements 404-408, 412, 416-418, and 426-428 as shown in FIG. 4) may be in communication with one another using any suitable communication technologies. It will be recognized that although components and their corresponding elements are shown to be separate in FIG. 4, any of components and their corresponding elements may be combined into fewer components, such as into a single facility or module, divided into more components, or configured into different components as may serve a particular embodiment.

The components and their corresponding elements can comprise software, hardware, or both. For example, the components and their corresponding elements can comprise one or more instructions stored on a computer-readable storage medium and executable by processors of one or more computing devices. When executed by the one or more processors, the computer-executable instructions of the segmentation system 400 can cause a client device and/or a server device to perform the methods described herein. Alternatively, the components and their corresponding elements can comprise hardware, such as a special purpose processing device to perform a certain function or group of functions. Additionally, the components and their corresponding elements can comprise a combination of computer-executable instructions and hardware.

Furthermore, the components of the segmentation system 400 may, for example, be implemented as one or more stand-alone applications, as one or more modules of an application, as one or more plug-ins, as one or more library functions or functions that may be called by other applications, and/or as a cloud-computing model. Thus, the components of the segmentation system 400 may be implemented as a stand-alone application, such as a desktop or mobile application. Furthermore, the components of the segmentation system 400 may be implemented as one or more web-based applications hosted on a remote server. Alternatively, or additionally, the components of the segmentation system 400 may be implemented in a suite of mobile device applications or “apps.”

As shown, the segmentation system 400 can be implemented as a single system. In other embodiments, the segmentation system 400 can be implemented in whole, or in part, across multiple systems. For example, one or more functions of the segmentation system 400 can be performed by one or more servers, and one or more functions of the segmentation system 400 can be performed by one or more client devices. The one or more servers and/or one or more client devices may generate, store, receive, and transmit any type of data used by the segmentation system 400, as described herein.

In one embodiment, the one or more client devices can include or implement at least a portion of the segmentation system 400. In other embodiments, the one or more servers can include or implement at least a portion of the segmentation system 400. For instance, the segmentation system 400 can include an application running on the one or more servers or a portion of the segmentation system 400 can be downloaded from the one or more servers. Additionally or alternatively, the segmentation system 400 can include a web hosting application that allows the client device(s) to interact with content hosted at the one or more server(s).

For example, upon a client device accessing a webpage or other web application hosted at the one or more servers, in one or more embodiments, the one or more servers can provide access to a user interface displayed at a client device. The client device can prompt a user for a video sequence. Upon receiving the video sequence, the client device can provide the video sequence to the one or more servers, which can automatically perform the methods and processes described herein to segment objects in each frame of the video. The one or more servers can then provide access to the user interface displayed at the client device with segmented objects of the video.

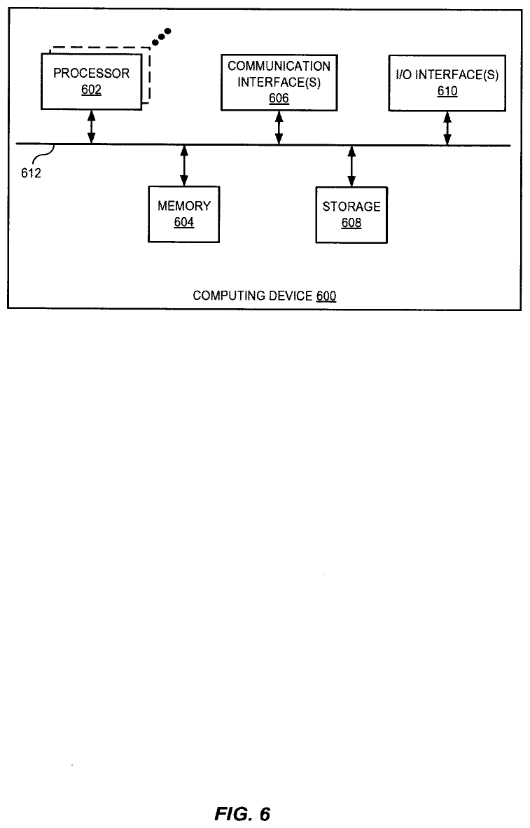

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 6. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 6.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 6.

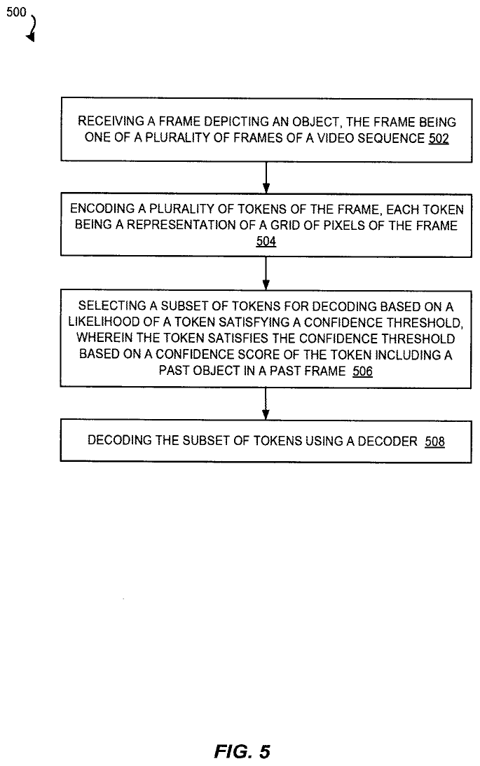

FIGS. 1-4, the corresponding text, and the examples, provide a number of different systems and devices that allows a user to perform panoptic segmentation. In addition to the foregoing, embodiments can also be described in terms of flowcharts comprising acts and steps in a method for accomplishing a particular result. For example, FIG. 5 illustrates a flowchart of an exemplary method in accordance with one or more embodiments. The method described in relation to FIG. 5 may be performed with fewer or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart 500 of a series of acts in a method of selecting active regions for panoptic segmentation in accordance with one or more embodiments. In one or more embodiments, the method 500 is performed in a digital medium environment that includes the segmentation system 400. The method 500 is intended to be illustrative of one or more methods in accordance with the present disclosure and is not intended to limit potential embodiments. Alternative embodiments can include additional, fewer, or different steps than those articulated in FIG. 5.

As illustrated in FIG. 5, the method 500 includes an act 502 of receiving a frame depicting an object (e.g., a frame including a representation of an object). As described herein, the frame may be one frame of a plurality of frames of a video sequence. Specifically, the frame is an instantaneous image of the input video determined by partitioning the input video into frames.

As illustrated in FIG. 5, the method 500 includes an act 504 of encoding a plurality of tokens of the frame. As described herein, each token is a representation of a grid of pixels of the frame. Tokens may be encoded by transforming each grid of pixels into a representation of a grid of pixels by extracting features of pixels in the token. Encoding the frame into a plurality of feature maps or other numerical representation allows for the identification of objects in the frame using memory representations, as described herein.

As illustrated in FIG. 5, the method 500 includes an act 506 of selecting a subset of tokens for decoding based on a likelihood of a token satisfying a confidence threshold. As described herein, the token satisfies the confidence threshold based on a confidence score of the token including a past object in a past frame. Specifically, every grid of the frame is compared to a memory key, which encodes a representation of visual information on its underlying region in previous frames. In this manner, memory of past masked object of past masks is applied to a current frame. The resulting affinity matrix indicates whether pixels in the current frame are similar to pixels in the past frames that include masked objects. Subsequently, a memory value, encoding a location of a particular object in previous frames, is applied to the affinity matrix. As a result, memory readouts corresponding to each object of a past mask with respect to the current frame are determined. Tokens of the memory readout are selected for decoding based on tokens of the memory readout satisfying a confidence threshold, where the confidence threshold is based on a likelihood of the token including a past object based on a past mask of the object. As described herein, tokens are selected for decoding based on identifying tokens of the current frame in which there is a high confidence of the presence of an object, based on previous objects identified in previous frames/masks.

As illustrated in FIG. 5, the method 500 includes an act 508 of decoding the subset of tokens using a decoder. The result is a masked frame of the received frame, where the object in the received frame has been segmented. Even though only a subset of tokens were decoded, the dimensions of the masked frame are the same as those of the received frame. As described herein, the segmentation system leverages the spatial redundancy of the received frame to decode only a portion of the frame, while still being able to create a segmented representation of the received frame.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates, in block diagram form, an exemplary computing device 600 that may be configured to perform one or more of the processes described above. One will appreciate that one or more computing devices such as the computing device 600 may implement the segmentation system. As shown by FIG. 6, the computing device can comprise a processor 602, memory 604, one or more communication interfaces 606, a storage device 608, and one or more I/O devices/interfaces 610. In certain embodiments, the computing device 600 can include fewer or more components than those shown in FIG. 6. Components of computing device 600 shown in FIG. 6 will now be described in additional detail.

In particular embodiments, processor(s) 602 includes hardware for executing instructions, such as those making up a computer program. As an example, and not by way of limitation, to execute instructions, processor(s) 602 may retrieve (or fetch) the instructions from an internal register, an internal cache, memory 604, or a storage device 608 and decode and execute them. In various embodiments, the processor(s) 602 may include one or more central processing units (CPUs), graphics processing units (GPUs), field programmable gate arrays (FPGAs), systems on chip (SoC), or other processor(s) or combinations of processors.

The computing device 600 includes memory 604, which is coupled to the processor(s) 602. The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The computing device 600 can further include one or more communication interfaces 606. A communication interface 606 can include hardware, software, or both. The communication interface 606 can provide one or more interfaces for communication (such as, for example, packet-based communication) between the computing device and one or more other computing devices 600 or one or more networks. As an example and not by way of limitation, communication interface 606 may include a network interface controller (NIC) or network adapter for communicating with an Ethernet or other wire-based network or a wireless NIC (WNIC) or wireless adapter for communicating with a wireless network, such as a WI-FI. The computing device 600 can further include a bus 612. The bus 612 can comprise hardware, software, or both that couples components of computing device 600 to each other.

The computing device 600 includes a storage device 608 includes storage for storing data or instructions. As an example, and not by way of limitation, storage device 608 can comprise a non-transitory storage medium described above. The storage device 608 may include a hard disk drive (HDD), flash memory, a Universal Serial Bus (USB) drive or a combination these or other storage devices. The computing device 600 also includes one or more input or output (“I/O”) devices/interfaces 610, which are provided to allow a user to provide input to (such as user strokes), receive output from, and otherwise transfer data to and from the computing device 600. These I/O devices/interfaces 610 may include a mouse, keypad or a keyboard, a touch screen, camera, optical scanner, network interface, modem, other known I/O devices or a combination of such I/O devices/interfaces 610. The touch screen may be activated with a stylus or a finger.

The I/O devices/interfaces 610 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 610 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving a frame depicting an object, the frame being one of a plurality of frames of a video sequence;
encoding a plurality of tokens of the frame, each token being a representation of a grid of pixels of the frame;
selecting a subset of tokens for decoding based on a likelihood of a token satisfying a confidence threshold, wherein the token satisfies the confidence threshold based on a confidence score of the token including a past object in a past frame; and
decoding the subset of tokens using a decoder.

2. The method of claim 1, further comprising:
encoding a representation of visual information in the past frame;
creating an affinity matrix by comparing each token of the plurality of tokens to the encoded representation of visual information in the past frame;
encoding a mask probability of a particular past object in the past frame; and
obtaining a memory readout for the particular past object by applying the encoded mask probability of the particular past object in the past frame to the affinity matrix.

3. The method of claim 2, further comprising:
encoding an existence of a particular masked object.

4. The method of claim 3, further comprising:
determining the confidence score of the token including the past object in the past frame by applying the existence of the particular masked object to the memory readout for the particular past object.

5. The method of claim 1, wherein the decoder is a set-based decoder and further comprising:
indexing the subset of tokens; and
decoding the indexed subset of tokens.

6. The method of claim 1, wherein the decoder is a convolutional decoder and further comprising:
masking each of the plurality of tokens of the frame that are not included in the subset of tokens.

7. The method of claim 1, further comprising:
receiving a second frame including at least two objects;
encoding a second plurality of tokens of the second frame, each token being a representation of a grid of pixels of the second frame; and
selecting a second subset of tokens for decoding based on a likelihood of a token of the second frame satisfying the confidence threshold, wherein the second subset of tokens includes a first set of tokens corresponding to a first object and a second set of tokens corresponding to a second object.

8. The method of claim 7, further comprising:
determining that the first set of tokens representing a grid of pixels of the second frame is a number of pixels apart from the second set of tokens representing another grid of pixels of the second frame;
masking each of the plurality of tokens of the second frame that are not included in the second subset of tokens;
combining the first set of tokens of the second subset and the second set of tokens of the second subset into a single encoded representation; and
decoding the single encoded representation.

9. The method of claim 1, wherein the subset of tokens is an active region corresponding to the object of the frame.

10. A system comprising:
a memory component; and
a processing device coupled to the memory component, the processing device to perform operations comprising:
receiving a frame depicting an object, the frame being one of a plurality of frames of a video sequence;
encoding a plurality of tokens of the frame, each token being a representation of a grid of pixels of the frame;
selecting a subset of tokens for decoding based on a likelihood of a token satisfying a confidence threshold, wherein the token satisfies the confidence threshold based on a confidence score of the token including a past object in a past frame; and
decoding the subset of tokens using a decoder.

11. The system of claim 10, wherein the processing device performs further operations comprising:
encoding a representation of visual information in the past frame;
creating an affinity matrix by comparing each token of the plurality of tokens to the encoded representation of visual information in the past frame;
encoding a mask probability of a particular past object in the past frame; and
obtaining a memory readout for the particular past object by applying the encoded mask probability of the particular past object in the past frame to the affinity matrix.

12. The system of claim 11, wherein the processing device performs further operations comprising:
encoding an existence of a particular masked object.

13. The system of claim 12, wherein the processing device performs further operations comprising:
determining the confidence score of the token including the past object in the past frame by applying the existence of the particular masked object to the memory readout for the particular past object.

14. The system of claim 10, wherein the decoder is a set-based decoder and the processing device performs further operations comprising:
indexing the subset of tokens; and
decoding the indexed subset of tokens.

15. The system of claim 10, wherein the decoder is a convolutional decoder and the processing device performs further operations comprising:
masking each of the plurality of tokens of the frame that are not included in the subset of tokens.

16. The system of claim 10, wherein the processing device performs further operations comprising:
receiving a second frame including at least two objects;
encoding a second plurality of tokens of the second frame, each token being a representation of a grid of pixels of the second frame; and
selecting a second subset of tokens for decoding based on a likelihood of a token of the second frame satisfying the confidence threshold, wherein the second subset of tokens includes a first set of tokens corresponding to a first object and a second set of tokens corresponding to a second object.

17. The system of claim 16, wherein the processing device performs further operations comprising:
determining that the first set of tokens representing a grid of pixels of the second frame is a number of pixels apart from the second set of tokens representing another grid of pixels of the second frame;
masking each of the plurality of tokens of the second frame that are not included in the second subset of tokens;
combining the first set of tokens of the second subset and the second set of tokens of the second subset into a single encoded representation; and
decoding the single encoded representation.

18. A non-transitory computer-readable medium storing executable instructions, which when executed by a processing device, cause the processing device to perform operations comprising:
receiving a frame depicting an object, the frame being one of a plurality of frames of a video sequence;
encoding a plurality of tokens of the frame, each token being a representation of a grid of pixels of the frame;
determining an existence metric by encoding an existence of a past masked object in a past masked frame;
determining a confidence value of each token of the plurality of tokens of the frame including the past masked object using the existence metric;
determining to decode one or more tokens of the plurality of tokens of the frame based on the confidence value satisfying a confidence threshold; and
decoding the one or more tokens using a decoder.

19. The non-transitory computer-readable medium of claim 18, wherein using the existence metric further comprises:
applying the existence metric to a representation of the object in the frame.

20. The non-transitory computer-readable medium of claim 19, storing instructions that further cause the processing device to perform operations comprising:
encoding a representation of visual information in a past frame;
creating an affinity matrix by comparing each token of the plurality of tokens of the frame to the encoded representation of visual information in the past frame;
encoding a mask probability of a past object in the frame; and
applying the encoded mask probability of the past object in the past frame to the affinity matrix to obtain the representation of the object in the frame.
